(19) United States
(12) Patent Application Publication
(10) Pub. No.: US 2026/0267301 A1
(43) Pub. Date: Sep. 10, 2026

(54) Method and System for Operating a Technical Device with a Meta-Learning Model

(71) Applicant: Siemens Aktiengesellschaft, Muenchen (DE)

(72) Inventors: Stephanie HOLLY, Wien (AT); Jana EDER, Wien (AT); Ahmed FRIKHA, Karlsruhe (DE); Thomas BIERWEILER, Karlsruhe (DE); Stefan VON DOSKY, Karlsruhe (DE); Daniel SCHALL, Wien (AT)

(21) Appl. No.: 19/165,652

(22) PCT Filed: Mar. 12, 2024
(86) PCT No.: PCT/EP2024/056583

§ 371 Date: Sep. 16, 2025

(30) Foreign Application Priority Data
Mar. 17, 2023 (EP) 23162672.2

(51) Int. Cl. G05B 13/04; G05B 13/02

(52) U.S. Cl. CPC G05B 13/042; G05B 13/0265

(57) ABSTRACT

A computer-implemented method for operating a technical device with a meta-learning model, where the method includes a) generating and initializing the model for the technical device, b) generating a set of machine learning tasks, c) selecting at least one task from the set of tasks, d) determining a first subset having a permissible operating mode, e) determining a second subset having all operating modes, f) training the model with the first subset, g) training the model with the second subset, h) determining an adapted second set of model parameters, i) continuing with d) until reaching a predetermined first termination criterion, j) implementing a meta update of the first set of model parameters for the model, k) continuing with c) until reaching a predetermined second termination criterion, l) re-training the model with at least one further task, and m) operating the technical device with the model.

### CROSS-REFERENCE TO RELATED APPLICATIONS

This is a U.S. national stage of application No. PCT/EP2024/056583 filed 12 Mar. 2024. Priority is claimed on European Application No. 23162672.2 filed 17 Mar. 2023, the content of which is incorporated herein by reference in its entirety.

### BACKGROUND OF THE INVENTION

### 1. Field of the Invention

The invention relates to a computer-implemented method, a computer program product and a system for operating a technical device with a meta-learning model, where the technical device has operating modes that are defined by respective predetermined device parameters.

### 2. Description of the Related Art

Devices in an industrial setting are frequently operated with models based on artificial intelligence (“AI”) in order, for example, to implement a predictive maintenance. This occurs in that future operation is predicted with the aid of a model comprising current operating parameters.

A model must be laboriously trained and is then frequently only valid for one installation of a device. If a structurally identical device is installed or arranged in some other way therefore, then in accordance with, the prior art the model thus has to be laboriously re-trained.

The publication ANUSHA NAGABANDI ET AL. “Learning to Adapt in Dynamic, Real-World Environments Through Meta-Reinforcement Learning”, ARXIV.ORG, CORNELL UNIVERSITY LIBRARY, 201 OLIN LIBRARY CORNELL UNIVERSITY ITHACA, NY 14853, Mar. 30, 2018, shows a special method for sample-efficient learning with the aid of meta-learning, in order to train a dynamic model in advance, so that, when combined with current data, the model can be adapted to a local context in a rapid manner.

In the prior art, it is very difficult to transfer an AI model, which was trained for a device, such as a pump, which is situated in one environment, to the identical device or similar devices in a different environment.

The setting or the operating environment relates, for example, to installed state, screw connection, floor characteristics or adjacent plant. The environment can influence the data and frequently undesirably results in other data distributions in the measured values.

### SUMMARY OF THE INVENTION

In view of the foregoing, it is therefore an object of the invention to provide a solution in which a model for a device can be easily generated but the model is still accurate even when it is not trained for an additional operating mode.

This and other objects and advantages are achieved in accordance with the invention by a computer-implemented method for operating a technical device with a meta-learning model, where the technical device has operating modes which are defined by respective predetermined device parameters, and the following acts are executed:
a) generating and initializing the model for the technical device in operating environments that are defined by respective operating parameters, and the model is defined by a first set of model parameters,
b) generating a set of machine learning tasks, where one task from the set of tasks defines an operation of the technical device in an operating environment with operating parameters, and all tasks from the set of tasks match in all operating modes for the technical device,
c) selecting at least one task from the set of tasks,
d) determining a first subset in the form of samples, with a predefined first number of tasks from the set of tasks, which have a permissible operating mode,
e) determining a second subset in the form of samples, with a predefined second number of tasks from the set of tasks, which have all operating modes,
f) training the model with the first subset with the aid of updates in accordance with a gradient method,
g) training the model with the second subset, with the aid of updates in accordance with a gradient method
h) determining an adapted second set of model parameters from the model with the aid of updates in accordance with a gradient method,
i) continuing with step d) until a predetermined first termination criterion is reached,
j) implementing a meta update of the first set of model parameters for the model with the aid of the adapted second set of model parameters based on the first set of model parameters,
k) continuing with step c) until a predetermined second termination criterion is reached,
l) re-training the model with at least one further task, and
m) operating the technical device with the model.

The set of tasks should be taken to mean meta-trainings tasks.

The first number of tasks from the set of tasks should be understood to mean what is known as a “Support Set”, which tasks have a permissible operating mode for the technical device.

The second number of tasks from the set of tasks should be understood to mean what is known as a “Query Set”, which tasks have all operating modes for the technical device.

The first and/or the second termination criterion can refer to a minimum extent of changes in the gradient method, within the meaning of a convergence.

It is consequently possible to train an AI model, for example, in a laboratory environment, with permissible operating modes and to then transfer this AI model to a new installation with a high degree of accuracy of the model without the model having to be adapted or re-trained (Plug & Classify).

This makes it possible to scale AI models in industrial applications because models can be re-used with additional outlay.

Training the technical device can comprise all operation conditions, both permissible operating modes as well as impermissible operating modes, which can cause, for example, an operating anomaly.

Operating environments can map, for example, the assembly of the technical device, as well as a cable routing or also influences of adjacent apparatuses.

Meta-learning in machine learning denotes learning algorithms which learn from other learning algorithms. Algorithms that learn how the predictions of other algorithm for machine learning can best be combined in the field of ensemble learning can also be used for machine learning.

Operating environments are environments in which the technical device, such as an electrical pump, is operated, for example, operating voltage ranges, temperature ranges, and/or speed ranges of the pump.

Operating environments are defined by respective operating parameters, such as range limits for voltages, temperatures, and/or motor characteristic figures of the pump.

There are various operating modes for the technical device, such as permissible or impermissible operating modes.

Permissible operating modes describe, for example, a trouble-free or advantageous operation of the technical device, in which good performance, efficient operation and low wear can be predicted.

Impermissible operating modes describe, for example, an undesirable or impaired operation of the technical device, due to which a disruption, inadequate efficiency during operation or premature wear can be predicted.

A mode for a high flow rate of a pump or a mode for a low power consumption of a pump can serve as exemplary permissible operating modes of the pump.

An operating mode that results in the wear being permanently too high or if the reliability of the pump cannot be maintained can serve as exemplary impermissible operating modes of the pump.

The operation of the technical device in an operating environment with thus defined by operating parameters, which also map operating environments.

Accordingly, operating parameters or operating environments can be derived in model parameters which define the model.

In one embodiment of the invention, the gradient method is the gradient descent algorithm.

A rapid convergence of the iterative or recursive method is consequently achieved particularly efficiently.

In another embodiment of invention, the model is trained with the second subset with the aid of an update in accordance with a modified gradient descent algorithm, preferably based on second order derivatives.

A particularly rapid convergence of the iterative or recursive method is consequently achieved particularly efficiently.

In a further embodiment of the invention, the adapted second set of model parameters is determined with the aid of an update according to a modified gradient descent algorithm.

A further-improved and rapid convergence of the iterative or recursive method is consequently achieved particularly efficiently.

In another embodiment of the invention, the predetermined first termination criterion is reaching a predetermined first number of repetitions.

An easy-to-implement criterion for the iterative or recursive method is consequently achieved particularly easily.

In a further embodiment of the invention, the predetermined second termination criterion is reaching a predetermined second number of repetitions.

An easy-to-implement criterion for the iterative or recursive method is consequently achieved particularly easily.

In yet another embodiment of the invention, the device parameters comprise a combination of device characteristic variables and/or a value range for at least one device characteristic variable.

A further-improved and rapid convergence of the iterative or recursive method is consequently achieved particularly efficiently.

The model can be initialized in step a) with the aid of predetermined initialization values.

In a still further embodiment of the invention, the model is initialized in step a) with random values.

In other words, the predetermined initialization values can be random values.

The initialization can consequently occur particularly easily.

At least one task can be selected in step c) with the aid of a predetermined selection.

In another embodiment of the invention, at least one task is randomly selected in step c).

In other words, the predetermined selection can be determined by random values.

The selection can consequently occur particularly easily.

The objects and advantages in accordance with the invention are also achieved by a system for operating a technical device with a meta-learning model, comprising a computing apparatus with a processor and a memory, which is equipped to operate the technical device, and the system is configured to execute the method.

The objects and advantages are also achieved in accordance with the invention by a computer program product with machine-readable instructions stored therein which, when executed by a processing unit, prompt it to execute the method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below on the basis of an exemplary embodiment represented in the attached drawings. In the drawings:

FIG. 1 shows an exemplary embodiment of the invention as program code;

FIG. 2 shows a schematic representation of a system for operating a technical device with a model based on artificial intelligence, with the respective input variables; and

FIG. 3 shows a flowchart of the inventive method.

### DETAILED DESCRIPTION OF THE EXEMPLARY EMBODIMENTS

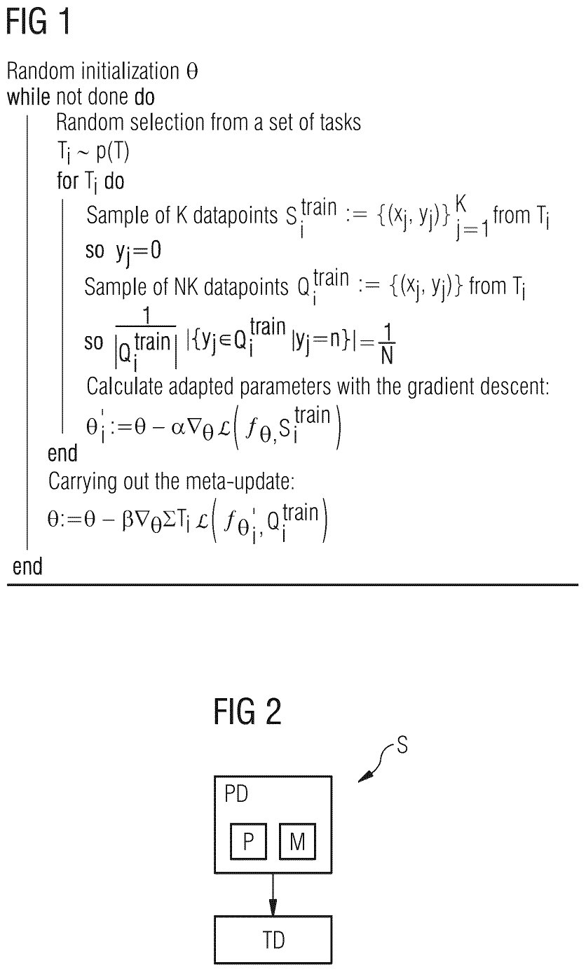

FIG. 1 shows an exemplary embodiment of a computer program product in the form of a program code, in which embodiment meta learning is implemented based on one or fewer categories.

A set of tasks T is provided that has a distribution p(T) over the tasks.

A model architecture ƒ_{θ}, which can be set by the parameter θ.

Further, a loss function [symbol] is specified as well as an increment of the hyperparameters α, β.

A total number of categories N is specified for a simple implementation.

FIG. 2 shows a schematic representation of a system for operating a technical device with a meta-learning model.

The system comprises a computing apparatus with a processor and a memory that is equipped to operate the technical device.

The system is configured to execute the below-described.

Based on the system, it is possible to also provide a computer program product with machine-readable instructions stored therein which, when executed by a processing unit, prompt it to execute the method.

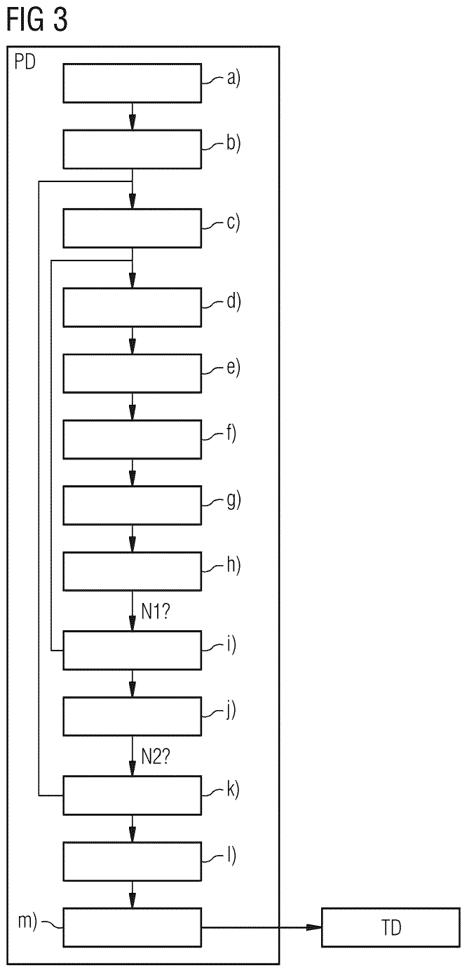

FIG. 3 illustrates a flowchart of the inventive method.

The computer implemented method for operating a technical device TD with a meta-learning model, where the technical device has operating modes which are defined by respective predetermined device parameters, comprises the following acts:
a) generating and randomly initializing the model for the technical device TD in operating environments that are defined by respective operating parameters, and the model is defined by a first set of model parameters THETA,
b) generating a set of machine learning tasks, where one task from the set of tasks defines operation of the technical device TD in an operating environment with operating parameters, and all tasks from the set of tasks match in all operating modes for the technical device TD,
c) selecting randomly at least one task T from the set of tasks,
d) determining a first subset in the form of samples, with a predefined first number Kl of tasks from the set of tasks, which have a permissible operating mode, also referred to as a “Support Set”,
e) determining a second subset in the form of samples, with a predefined second number K2 of tasks from the set of tasks, which have all operating modes, also referred to as a “Query Set”,
f) training the model with the first subset, with the aid of updates in accordance with a gradient method,
g) training the model with the second subset, with the aid of updates in accordance with a gradient method,
h) determining an adapted second set of model parameters THETA′ from the model with the aid of updates in accordance with a gradient method,
i) continuing with step d) until a predetermined first termination criterion N1 is reached,
j) implementing a meta update of the first set of model parameters for the model with the aid of the adapted second set of model parameters THETA′ based on the first set of model parameters THETA,
k) continuing with step c) until a predetermined second termination criterion N2 is reached,
l) re-training the model with at least one further task, and
m) operating the technical device TD with the model.

The model is initialized in step a) with random values. Alternatively, predetermined values, for example, can also be used, however.

At least one task is randomly selected in step c). Alternatively, predetermined tasks, for example, can also be used, however, such as via a predetermined order in a data structure that is used for storing the set of tasks.

The gradient method is preferably the gradient descent algorithm.

The model can be trained with the second subset, for example, with the aid of an update in accordance with a modified gradient descent algorithm, preferably based on second order derivatives.

The adapted second set of model parameters can be determined, for example, with the aid of an update according to a modified gradient descent algorithm.

The predetermined first termination criterion can be reaching a predetermined first number N1 of repetitions.

The predetermined second termination criterion can be reaching a predetermined second number N2 of repetitions.

The device parameters can comprise a combination of device characteristic variables and/or a value range for at least one device characteristic variable.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A computer-implemented method for operating a technical device with a meta-learning model, the technical device including operating modes which are defined by respective predetermined device parameters, the method comprising:
a) generating and initializing the model for the technical device in operating environments which are defined by respective operating parameters, the model being defined by a first set of model parameters;
b) generating a set of machine learning tasks, one task from the set of tasks defining an operation of the technical device in an operating environment with operating parameters, and all tasks from the set of tasks matching in all operating modes for the technical device;
c) selecting at least one task from the set of tasks;
d) determining a first subset forming samples, with a predefined first number of tasks from the set of tasks, which have a permissible operating mode;
e) determining a second subset forming samples, with a predefined second number of tasks from the set of tasks, which have all operating modes;
f) training the model with the first subset, aided by updates, in accordance with a gradient method;
g) training the model with the second subset, aided by updates, in accordance with the gradient method;
h) determining an adapted second set of model parameters from the model, aided by the updates, in accordance with the gradient method;
i) continuing with determining the first subset until a predetermined first termination criterion is reached;
j) implementing a meta update of the first set of model parameters for the model, aided by the adapted second set of model parameters, based on the first set of model parameters;
k) continuing selecting the at least one task from the set of tasks until a predetermined second termination criterion is reached;
l) re-training the model with at least one further task; and
m) operating the technical device with the re-trained model.

13. The method as claimed in claim, 12 wherein the gradient method is the gradient descent algorithm.

14. The method as claimed in claim 13, wherein the model with the second subset is trained aided by an update in accordance with a modified gradient descent algorithm based on second order derivatives.

15. The method as claimed in claim 13, wherein the adapted second set of model parameters is determined aided by an update in accordance with a modified gradient descent algorithm.

16. The method as claimed in claim 14, wherein the adapted second set of model parameters is determined aided by an update in accordance with a modified gradient descent algorithm.

17. The method as claimed in claim 12, wherein the predetermined first termination criterion is reaching a predetermined first number of repetitions.

18. The method as claimed in claim 12, wherein the predetermined second termination criterion is reaching a predetermined second number of repetitions.

19. The method as claimed in claim 12, wherein the device parameters comprise at least one of a combination of device characteristic variables and a value range for at least one device characteristic variable.

20. The method as claimed in claim 12, wherein the model is initialized with random values.

21. The method as claimed in claim 12, wherein at least one task is randomly selected.

22. A system for operating a technical device with a meta-learning model, comprising:
a computing apparatus including a processor and a memory, which is equipped to operate the technical device;
wherein the system is configured to:
a) generate and initialize the model for the technical device in operating environments which are defined by respective operating parameters, the model being defined by a first set of model parameters;
b) generate a set of machine learning tasks, one task from the set of tasks defining an operation of the technical device in an operating environment with operating parameters, and all tasks from the set of tasks matching in all operating modes for the technical device;
c) select at least one task from the set of tasks;
d) determine a first subset forming samples, with a predefined first number of tasks from the set of tasks, which have a permissible operating mode;
e) determine a second subset forming samples, with a predefined second number of tasks from the set of tasks, which have all operating modes;
f) train the model with the first subset, aided by updates, in accordance with a gradient method;
g) train the model with the second subset, aided by updates, in accordance with the gradient method;
h) determine an adapted second set of model parameters from the model, aided by the updates, in accordance with the gradient method;
i) continue determination of the first subset until a predetermined first termination criterion is reached;
j) implement a meta update of the first set of model parameters for the model, aided by the adapted second set of model parameters, based on the first set of model parameters;
k) continue selection of the at least one task from the set of tasks until a predetermined second termination criterion is reached;
l) re-train the model with at least one further task; and
m) operate the technical device with the re-trained model.

23. A non-transitory computer readable medium encoded with machine-readable instructions which, executed by a processor of a computing apparatus, prompt the computing apparatus to operate a technical device, the machine-readable instructions comprising:
a) program code for generating and initializing the model for the technical device in operating environments which are defined by respective operating parameters, the model being defined by a first set of model parameters;
b) program code for generating a set of machine learning tasks, one task from the set of tasks defining an operation of the technical device in an operating environment with operating parameters, and all tasks from the set of tasks matching in all operating modes for the technical device;
c) program code for selecting at least one task from the set of tasks;
d) program code for determining a first subset forming samples, with a predefined first number of tasks from the set of tasks, which have a permissible operating mode;
e) program code for determining a second subset forming samples, with a predefined second number of tasks from the set of tasks, which have all operating modes;
f) program code for training the model with the first subset, aided by updates, in accordance with a gradient method;
g) program code for training the model with the second subset, aided by updates, in accordance with the gradient method;
h) program code for determining an adapted second set of model parameters from the model, aided by the updates, in accordance with the gradient method;
i) program code for continuing with determining the first subset until a predetermined first termination criterion is reached;
j) program code for implementing a meta update of the first set of model parameters for the model, aided by the adapted second set of model parameters, based on the first set of model parameters;
k) program code for continuing selecting the at least one task from the set of tasks until a predetermined second termination criterion is reached;
l) program code for re-training the model with at least one further task; and
m) program code for operating the technical device with the re-trained model.
